(19) United States
(12) Patent Application Publication
(10) Pub. No.: US 2012/0324019 A1
(43) Pub. Date: Dec. 20, 2012

(54) SPAM MANAGEMENT AND REPORTING IN A MOBILE DEVICE

(76) Inventor: Zoltán Ördögh, Mississauga (CA)

(21) Appl. No.: 13/163,342

(22) Filed: Jun. 17, 2011

(51) Int. Cl. G06F 15/16

(52) U.S. Cl. 709/206

(57) ABSTRACT

Spam management by a mobile device includes transmitting an IMAP command to a voicemail server, the IMAP command identifying a voicemail associated with the mobile communication device as being a spam message; and receiving, relative to the IMAP command, a response regarding the spam message from the voicemail server.

### FIELD OF TECHNOLOGY

The present disclosure relates to electronic devices, including but not limited to, spam management and reporting in a mobile device.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart phones, wireless personal digital assistants (PDAs), and computers such as laptops and tablets with wireless (e.g. at least one of GPRS, EDGE, UMTS, EV-DO, HSDPA, LTE 802.11, 802.16 and Bluetooth) capabilities.

Unwanted communication such as unsolicited email and voicemail messages, which may be made to a number of recipients at once or may be made individually, has become common. Such unwanted communication may be referred to as spam communication, spam messages or simply, spam.

Improvements in the handling of spam communication are desirable.

### BRIEF DESCRIPTION OF THE DRAWINGS

FIG. 1 is a block diagram of an example system including a client device in communication with a server.

FIG. 2 includes flowcharts illustrating example processes that may be carried out by the client device and the server of FIG. 1 to mark messages that are transmitted to the client device as being spam.

FIG. 3 includes flowcharts illustrating example processes that may be carried out by the client device and the server of FIG. 1 to flag spam messages and provide prompts to move spam messages.

FIG. 4 includes flowcharts illustrating example processes that may be carried out by the client device and the server of FIG. 1 to flag and move spam messages.

FIG. 5 includes flowcharts illustrating example processes that may be carried out by the client device and the server of FIG. 1 to clear spam indications of previously-identified spam messages.

FIG. 6 is a block diagram of a portable electronic device in accordance with the disclosure.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The following describes apparatus for and methods of managing and reporting spam on a mobile device. One example type of spam that may be managed and reported in accordance with the apparatus and methods described herein may be voicemail spam.

The proposed methods may be carried out using one or more client devices and one or more servers that communicate using the protocol known as Internet Message Access Protocol (IMAP). IMAP is a widely adopted standard (RFC 3501) used to access stored messages such as electronic mail. IMAP is a secure, extensible protocol that requires authentication prior to accessing the message store. All information is available on an IMAP server, so there is no need to deal with spam that did not originate from the system itself.

As described herein, an enhanced visual voicemail (EVVM) system, which is specified by an Open Mobile Alliance (OMA) working group, can use new IMAP commands to flag messages as spam, suggest moving of messages that are spam, or move or delete messages that are spam. The IMAP commands support submitting spam reports via IMAP, and allow the server to take action based on the commands. For example, the server may handle spam by flagging the message, deleting the message, moving the message, etc. The IMAP commands also support clearing spam indications for messages that were previously identified as spam.

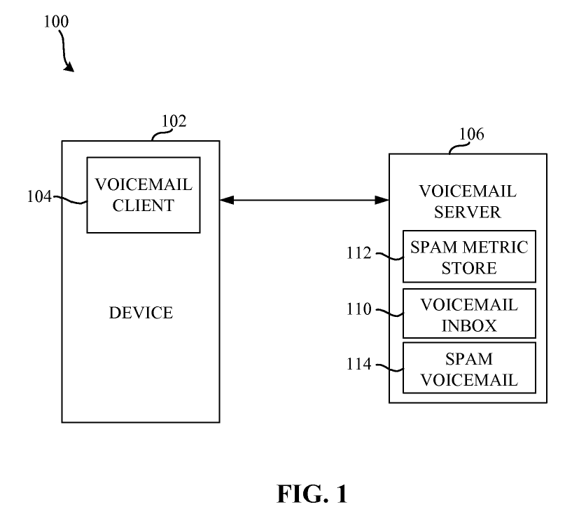

As shown in FIG. 1, a voicemail system, such as an EVVM system, may include a device 102, which includes a voicemail client 104, that communicates with a voicemail server 106. If the voicemail system is an EVVM system, the voicemail client 104 may present (or otherwise cooperate with another client or agent on the device to facilitate presentation of) a user interface allowing a user to view a list of messages that are available for playback, obtain a transcript of the messages, etc. As described herein, the communication between the voicemail client 104 and the voicemail server 106 may be carried out using IMAP to facilitate spam management.

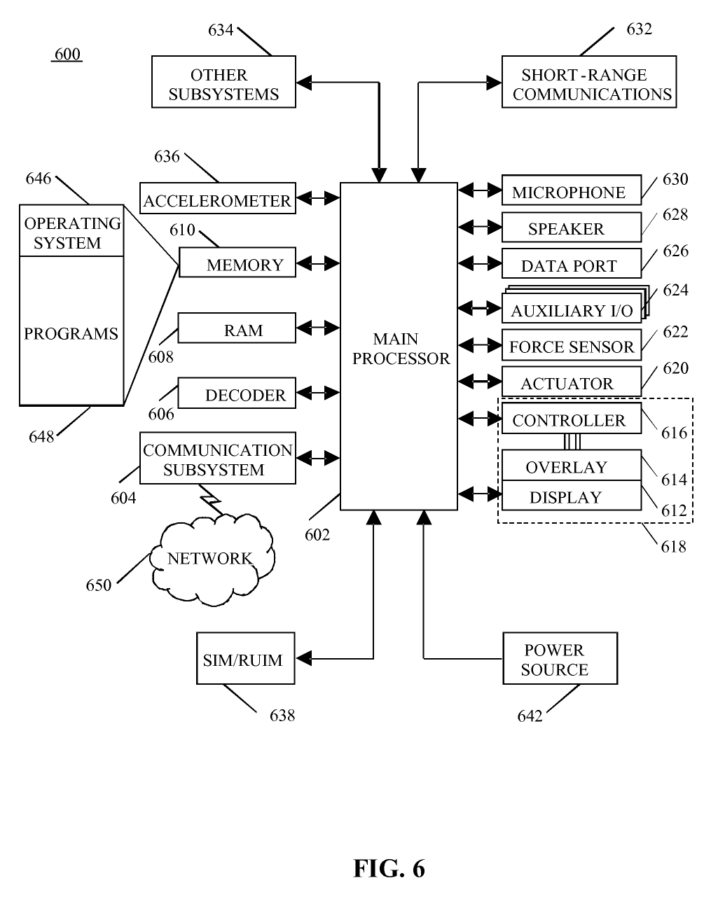

The device 102, certain aspects of which are described in detail below in conjunction with FIG. 6, may be implemented using a mobile communication device, such as a cellular telephone, a smart phone, including a programmed processor or memory, or any other hardware and software that is able to facilitate the operation of the voicemail client 104 and its interaction with the voicemail server 106. In addition to the voicemail client 104, the device 102 may implement other functionality such as data and voice communication, Internet browsing, etc.

The voicemail client 104 may be implemented using an EVVM client. In one example, the voicemail client 104 may be a software agent used to access and manage the voicemail repository on behalf of the user of the device 102 and offering a visual representation of the repository to the user. The agent may provide a local storage, such as a cache, to avoid downloading messages repeatedly or, to store draft messages before sending. The agent may also process the notifications sent by the server via a short message service (SMS) and update the local repository or connect to the voicemail server to fetch updates, if applicable.

The voicemail server 106 may be implemented as computer or machine readable instructions stored on a medium such as optical, magnetic or solid-state memory. When these instructions are executed on a processor of a server computer (e.g. blade server or the like) the instructions may effect a voicemail inbox 110, a spam metric store 112, and a spam voicemail box 114. The voicemail inbox 110 is a repository for voicemail associated with the voicemail client 104 of the device 102. As such, the voicemail inbox 110 may include messages that have not been provided to the voicemail client 104 and/or may store messages that have been presented on the device 102.

The spam metric store 112 may be a data structure (e.g. list) of attributes associated with voicemails that have been previously indicated to be or otherwise identified as spam. For example, the spam metric store 112 may be constituted of caller information, message content information, any other suitable information associated with previously received spam voicemails, or even the entire message. The spam metric store 112 may then be used in comparison to newly-received voicemails to determine if the newly-received voicemails are spam voicemails. While FIG. 1 shows that the spam metric store 112 is implemented using the voicemail server 106, it is possible that the spam metric store 112 may be implemented using resources outside of the voicemail server 106. Such resources may include existing SpamRep Enabler services as specified by the Open Mobile Alliance (OMA).

The spam voicemail box 114 stores voicemails that have been designated as spam, but have not yet been deleted from the voicemail server 106. In one example, the spam voicemail box 114 may store voicemail messages that the voicemail server 106 suspects to be spam, but such messages have not been confirmed to be spam. In another example, the spam voicemail box 114 may store voicemail messages that have been moved from the inbox to spam voicemail box 114 by the server 106 or according to an input, message or indication from the user.

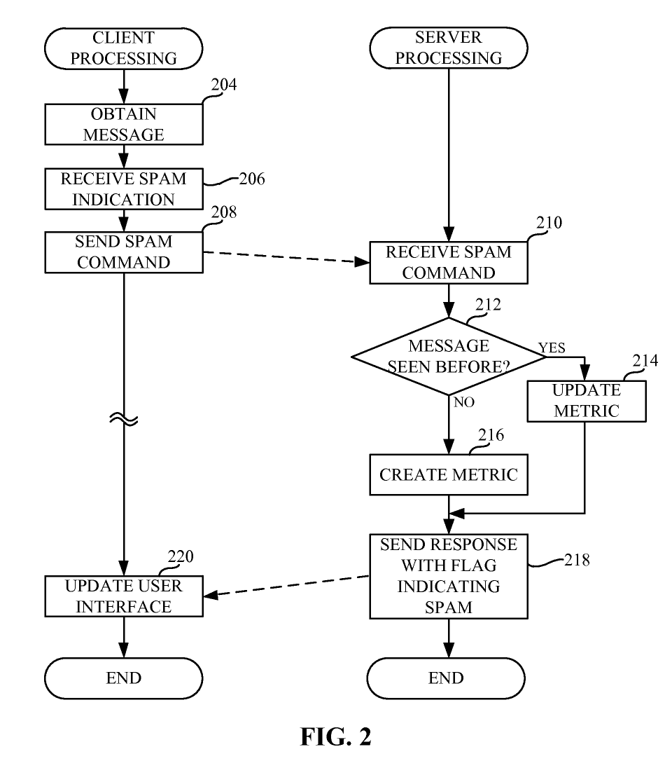

FIG. 2 shows flow diagrams indicative of operations that may occur on a client (e.g., a mobile device including hardware and software) and a server (e.g., a device including hardware and software) to flag one or more messages as spam. In some examples, the operations shown in the flow diagrams may be implemented by instructions executing on hardware, such as one or more processors. As shown in FIG. 2, a client obtains the message (block 204) and also receives a spam indication (block 206). The message may be received or obtained from a server, such as the voicemail server 106 using any suitable message push or pull mechanism. The spam indication is any suitable indication that identifies the message as being a spam message. For example, the message may be presented to a user on a display of the device or through a speaker of the device and the user may provide input to the device via a user interface indicating that the message is a spam message. The input may be made through keypresses on the device, or through any other suitable input.

After the spam indication is received, for example, from the user (block 206), a spam command is sent from the client to the server (block 208). In one example, the command may be an IMAP command named SPAMREP, which allows reporting spam (referred to as the SET directive) and reporting that a message (that was reported spam earlier) is no longer spam (referred to as the CLEAR directive). SPAMREP is sent with parameters or arguments including: directive, reference type, reference, and optionally includes a list of message part identifiers. SPAMREP may be issued for one or more messages at a time in the currently-selected mailbox.

The IMAP command named SPAMREP supports various messages and message identifier types. Thus, the reference type indicates the format of the reference. To use a unique identifier specified in RFC3501, the reference type may be UID and the reference may be “A number expressing the unique identifier of the message.” To use a sequence set specified in RFC3501, the reference type may be SEQ and the reference may be “sequence numbers corresponding to the specified message sequence number set.” To use an authorized URL specified in RFC4467, the reference type may be URLAUTH and the reference may be an “URLAUTH-authorized URL” authorizing the entire message. When the reference identifies one and only one message, the list of part identifiers may be included to improve the accuracy of spam detection. When the reference identifies more than one message, the list of part identifiers may be omitted. The list of part identifiers is a parenthesized list of part identifiers. Part identifiers identify either a header field or a body, and the dot (.) may be used as the separator character. Header fields may be identified by name. For example, the From header field is identified as “header.from”.

Message bodies may be identified by their position and depth in the message, where the first position is 1 and the main level is 1. To refer the entire body of a message or all bodies of a multipart message, the position and the depth may be omitted. For example, the entire body of a message (or all bodies of a multipart message) is identified as “body”. Considering a simple multipart message, the part following the first boundary is identified as “body.1”. Considering a multipart message that includes an email attachment following the second boundary, and the email attachment containing text following the first boundary, the text within the email message is identified as “body.2.1”.

For example, a client may send “A020 SPAMREP SET SEQ 10” to indicate that a single message (identified as the tenth message in a sequence of messages) is spam. A client may send A020 SPAMREP SET SEQ 9 (header.from body.2) to report a single message as spam and identifies the header and the body of the message as spam parts.

The server receives the spam command (block 210) and determines if the message indicated in the spam command has been seen previously (block 212). If the message has been seen previously, i.e., this spam has been previously encountered, a metric related to this type of spam is updated (block 214). If, however, this type of spam has not been previously encountered, a metric is generated or created (block 216).

After the metric is updated (block 214) or created (block 216), the server sends a response with a flag indicating the message as spam (block 218). The response may include an OK indication to represent that the server processed the SET or CLEAR directive successfully. As described below, in some examples, the OK response to a SET directive includes either a KEYWORD, RELOCATE, RELOCATING, DELETE, or DELETED. Additionally, the OK response to a CLEAR directive may, in some examples, include KEYWORD, RELOCATE, RELOCATING. The KEYWORD response occurs in case the server decided that only the keywords should be updated, either because it does not wish to give any hint to the client, or, because it does not have sufficient information. The client may decide what to do with the message. The KEYWORD response with the flag indicating the message is spam is sent from the server (block 218) and the client updates the user interface (block 220) by, for example, flagging the message as spam using graphics, colors, or any other suitable technique that sets the spam message apart from other messages at the client that are not spam.

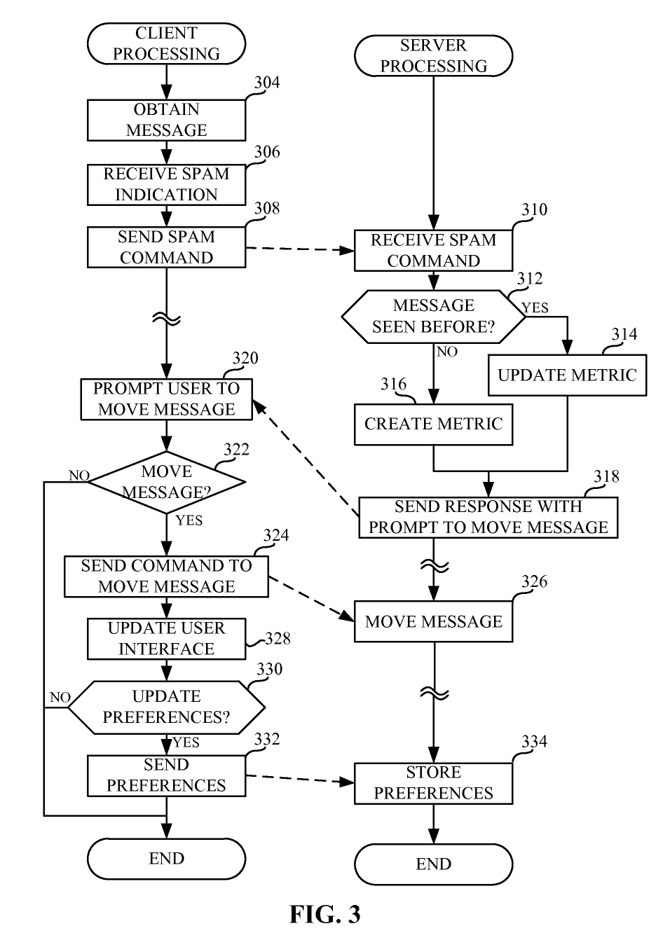

As noted above, the server may respond to a SET directive with an indication that a message should be relocated by communicating RELOCATE with the OK response. The RELOCATE response occurs in case the server decided that the message should be relocated, however leaves this action to the client. The client may decide what to do with the message. One example of a process showing this operation is in FIG. 3. The client obtains the message (block 304) and also receives a spam indication (block 306). As described above, the spam indication is any suitable indication that identifies the message as being a spam message. For example, the message may be presented to a user on a display of the device or through a speaker of the device and the user may provide input indicating that the message is a spam message. The input may be made through keypresses on the device, or through any other suitable input.

After the spam indication is received (block 306), a spam command is sent from the client to the server (block 308). In one example, the command may be the IMAP command SPAMREP described above

The server receives the spam command (block 310) and determines if the message indicated in the spam command has been seen previously (block 312). If the message has been seen previously, i.e., this spam has been previously encountered, a metric related to this type of spam is updated (block 314). If, however, this type of spam has not been previously encountered, a metric is created (block 316).

After the metric is updated (block 314) or created (block 316), the server sends a response with a flag indicating the message as spam and hints that the message should be moved using RELOCATE (block 318). For example, the response from the server may be “A020 OK [RELOCATE +$OMAEVVM10-spam-user-identified] SPAMREP Completed.”

The client may prompt the user to move the message (block 320) based on the response (block 318). If the message is to be moved (block 322), the command to move the message is sent to the server (block 324) and the message is moved by the server (block 326). The user interface of the client is then updated (block 328).

If the user preferences (e.g., a preference to have similar messages be automatically indicated as spam) are to be updated (block 330), those preferences are sent to the server (block 332). The server stores and/or updates the preferences (block 334).

While the foregoing description of FIG. 3 pertains to hinting, suggesting, or prompting a user to move a message using RELOCATE, a similar process may be carried out by hinting, suggesting, or prompting a user to delete a message using DELETE. The DELETE response occurs in case the server decided that the message should be deleted, however leaves this action to the client. The client may decide what to do with the message. For example, the response that is sent (block 318) may be “A020 OK [DELETE (+$OMAEVVM10-spam-user-identified-field.from +$OMAEVVM10-spam-user-identified-body.2)] SPAMREP Completed.” Based on this response, the user may be prompted to delete the subject spam message (block 322). Accordingly, FIG. 3 illustrates instances in which the server may hint at actions that a user may take and the client may then send the user's selections to the server for further processing. Example actions may include moving or deleting the subject spam message.

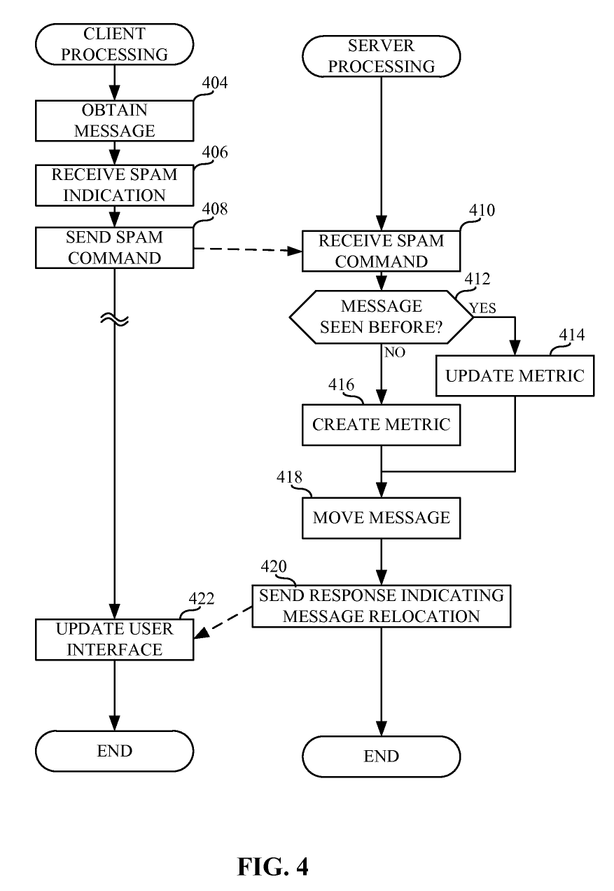

As noted above, the server may respond to a SET directive with an indication that a message is being relocated by communicating RELOCATING with the OK response. The RELOCATING response occurs in case the server decided that the message should be relocated, and it is going to relocate the message to the appropriate location after the response has been sent. The server may relocate the message by copying the message to the appropriate location and removing the original, just as if another client performed this action. One example of a process showing this operation is in FIG. 4. The client obtains the message (block 404) and also receives a spam indication (block 406). As described above, the spam indication is any suitable indication that identifies the message as being a spam message. For example, the message may be presented to a user on a display of the device or through a speaker of the device and the user may provide input indicating that the message is a spam message. The input may be made through keypresses on the device, or through any other suitable input.

After the spam indication is received (block 406), a spam command is sent from the client to the server (block 408). In one example, the command may be the IMAP command SPAMREP described above

The server receives the spam command (block 410) and determines if the message indicated in the spam command has been seen previously (block 412). If the message has been seen previously, i.e., this spam has been previously encountered, a metric related to this type of spam is updated (block 414). If, however, this type of spam has not been previously encountered, a metric is generated or created (block 416).

After the metric is updated (block 414) or created (block 416), moves or relocates the message (block 418). In one example, the spam message may be moved or relocated to a spam voicemail box (e.g., the spam voicemail box 114 of FIG. 1). The server also sends a response with a flag indicating the message as spam and indicates that the message has been moved using RELOCATED (block 420). For example, the response from the server may be “A020 OK [RELOCATED] SPAMREP Completed.”

The client receives the response and updates the user interface to move the message to the location indicated by the server (block 422). For example, message may be moved to a spam mailbox, or any other location, on the client.

While the foregoing description of FIG. 4 pertains to moving or relocating messages using RELOCATED, a similar process may be carried out by deleting a message using DELETED. The DELETED response occurs in case the server decided that the message should be deleted, and performed deletion. The server may delete the message, just as if another client performed this action. For example, the response that is sent (block 420) may be “A020 OK [DELETED] SPAMREP Completed.” Based on this response, the client will delete the message and update the user interface accordingly (block 422). Accordingly, FIG. 4 illustrates instances in which the server may take actions. Example actions may include moving or deleting the subject spam message.

It may be the case that a spam command that is sent from the client does not identify a message on the server. If this is the case, a response indicating NO is returned. In this case, the server does not perform any actions, and the client should reconcile the mailbox before repeating the request.

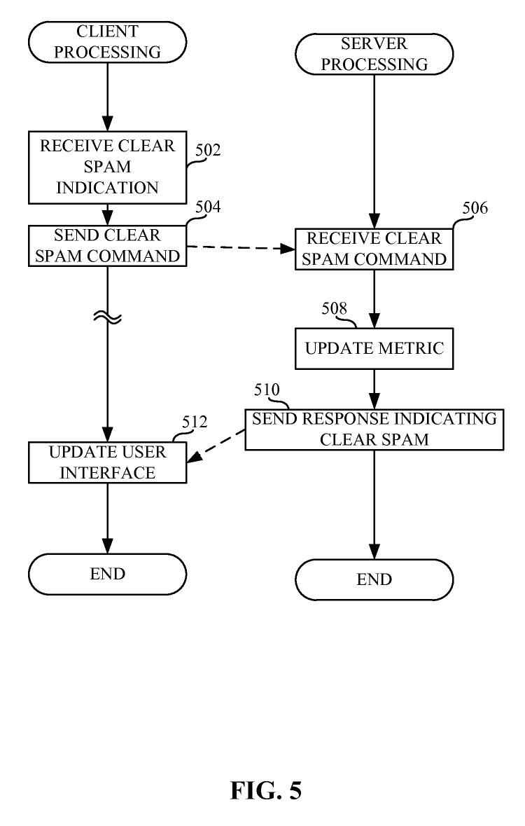

FIG. 5 shows client and server operations that may be carried out to clear a message that was previously indicated to be spam. As shown in FIG. 5, a clear spam indication is received by the client (block 502). The clear spam indication may be provided by a user of the device by, for example, key presses, or any other suitable manner in which a user can indicate that a particular message is no longer spam. A clear spam command is then sent from the client to the server (block 504). The clear spam command may identify a message as follows: “A020 SPAMREP CLEAR SEQ 10,” which indicates that the tenth message in a sequence of messages is to be cleared of an indication which previously identified the tenth message as being spam.

The server receives the clear spam command (block 506) and updates a metric associated with the message or messages that are to be cleared of being spam (block 508). The server also sends a response to the client indicating that the message is cleared of being spam (block 510). For example, the response may be “A020 OK [KEYWORD-$OMAEVVM10-spam-user-identified] SPAMREP Completed.” to indicate that no particular part of the message was indicated to be spam and that the relevant flags have been cleared. The server may respond with “A020 OK [KEYWORD (-$OMAEVVM10-spam-user-identified-field.from-$OMAEVVM10-spam-user-identified-body.2)] SPAMREP Completed” when the header and body were identified as spam, the server clears the appropriate flags. Additionally, the server may move the message (and may set/clear flags) and send a response of “A020 OK [RELOCATED] SPAMREP Completed.”

The client receives the response and updates the user interface to indicate that the subject message is not spam (block 512). In one example, the message may no longer be flagged as spam, or may be moved from one location on the device to another location.

A BAD result is returned in case the directive is CLEAR and one or more messages were not reported as spam earlier; the server may not perform any actions, and, in case the reference identified multiple messages in the original request, the client may attempt repeating the request on a per-message basis.

A block diagram of an example of a portable electronic device 600 is shown in FIG. 6. The portable electronic device 600 includes multiple components, such as a processor 602 that controls the overall operation of the portable electronic device 600. Communication functions, including data and voice communications, are performed through a communication subsystem 604. Data received by the portable electronic device 600 is decompressed and decrypted by a decoder 606. The decoder 606 may also be configured to compress and/or encrypt data which is to be sent via the communication subsystem 604. The communication subsystem 604 receives messages from and sends messages to a network 650. The network 650 may be any type of wired or wireless network, including, but not limited to, data wireless networks, voice wireless networks, and networks that support both voice and data communications. A power source 642, such as one or more rechargeable batteries or a port to an external power supply, powers the portable electronic device 600.

The processor 602 interacts with other components, such as Random Access Memory (RAM) 608, memory 610, a display 612 with a touch-sensitive overlay 614 operably coupled to an electronic controller 616 that together comprise a touch-sensitive display 618, one or more actuators 620, one or more force sensors 622, an auxiliary input/output (I/O) subsystem 624, a data port 626, a speaker 628, a microphone 630, short-range communications 632, and other device subsystems 634. Input via a graphical user interface is provided via the touch-sensitive overlay 614. The processor 602 interacts with the touch-sensitive overlay 614 via the electronic controller 616. Information, such as text, characters, symbols, images, icons, and other items that may be displayed or rendered on a portable electronic device, is displayed on the touch-sensitive display 618 via the processor 602. The processor 602 may interact with an accelerometer 636 that may be utilized to detect direction of gravitational forces or gravity-induced reaction forces.

To identify a subscriber for network access, the portable electronic device 600 may utilize a Subscriber Identity Module or a Removable User Identity Module (SIM/RUIM) card 638 for communication with a network, such as the wireless network 650. Alternatively, subscriber identification information may be programmed into memory 610.

The portable electronic device 600 includes an operating system 646 and software programs, applications, or components 648 that are executed by the processor 602 and are typically stored in a persistent, updatable store such as the memory 610. Additional applications or programs may be loaded onto the portable electronic device 600 through the wireless network 650, the auxiliary I/O subsystem 624, the data port 626, the short-range communications subsystem 632, or any other suitable subsystem 634.

A received signal such as a text message, an e-mail message, or web page download is processed by the communication subsystem 604 and input to the processor 602. The processor 602 processes the received signal for output to the display 612 and/or to the auxiliary I/O subsystem 624. A subscriber may generate data items, for example e-mail messages, which may be transmitted over the wireless network 650 through the communication subsystem 604. For voice communications, the overall operation of the portable electronic device 600 is similar. The speaker 628 outputs audible information converted from electrical signals, and the microphone 630 converts audible information into electrical signals for processing.

The touch-sensitive display 618 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display includes a capacitive touch-sensitive overlay 614. The overlay 614 may be an assembly of multiple layers in a stack including, for example, a substrate, a ground shield layer, a barrier layer, one or more capacitive touch sensor layers separated by a substrate or other barrier, and a cover. The capacitive touch sensor layers may comprise any suitable material, such as indium tin oxide (ITO).

One or more touches, also known as touch contacts or touch events, may be detected by the touch-sensitive display 618. The processor 602 may determine attributes of the touch, including a location of a touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 618. For example, the x location component may be determined by a signal generated from one touch sensor, and the y location component may be determined by a signal generated from another touch sensor. A signal is provided to the controller 616 in response to detection of a touch. A touch may be detected from any suitable input member, such as a finger, thumb, appendage, or other objects, for example, a stylus, pen, or other pointer, depending on the nature of the touch-sensitive display 618. Multiple simultaneous touches may be detected.

The actuator(s) 620 may be depressed or activated by applying sufficient force to the touch-sensitive display 618 to overcome the actuation force of the actuator 620. The actuator(s) 620 may be actuated by pressing anywhere on the touch-sensitive display 618. The actuator(s) 620 may provide input to the processor 602 when actuated. Actuation of the actuator(s) 620 may result in provision of tactile feedback. When force is applied, the touch-sensitive display 618 is depressible, pivotable, and/or movable. Such a force may actuate the actuator(s) 620. The touch-sensitive display 618 may, for example, float with respect to the housing of the portable electronic device, i.e., the touch-sensitive display 618 may not be fastened to the housing. A mechanical dome switch actuator may be utilized. In this example, tactile feedback is provided when the dome collapses due to imparted force and when the dome returns to the rest position after release of the switch. Alternatively, the actuator 620 may comprise one or more piezoelectric (piezo) devices that provide tactile feedback for the touch-sensitive display 618.

Optional force sensors 622 may be disposed in conjunction with the touch-sensitive display 618 to determine or react to forces applied to the touch-sensitive display 618. The force sensor 622 may be disposed in line with a piezo actuator 620. The force sensors 622 may be force-sensitive resistors, strain gauges, piezoelectric or piezoresistive devices, pressure sensors, quantum tunneling composites, force-sensitive switches, or other suitable devices. Force as utilized throughout the specification, including the claims, refers to force measurements, estimates, and/or calculations, such as pressure, deformation, stress, strain, force density, force-area relationships, thrust, torque, and other effects that include force or related quantities.

Flowcharts illustrating methods that may be carried out by a client or a server are shown in the drawings. These methods may be carried out by instructions executed, for example, by the processor 602, or any other processor that may be in a device or a server computer. Coding of instructions for carrying out such a method is within the scope of a person of ordinary skill in the art given the present description. The method may contain additional or fewer processes than shown and/or described, and may be performed in a different order. Computer-readable code executable by at least one processor of the portable electronic device to perform the method may be stored in a computer-readable medium, such as a non-transitory computer-readable medium.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method performed by a mobile communication device, comprising:
transmitting an IMAP command to a voicemail server, the IMAP command identifying a voicemail as being a spam message; and
receiving, a response relative to the IMAP command, regarding a disposition of the spam message from the voicemail server.

2. The method of claim 1 further comprising:
receiving a user input indicating that the voicemail is spam; and
generating the IMAP command relative to the user input.

3. The method of claim 1 wherein the response is configured to: suggest an action for a voicemail client on the mobile communication device to manage the spam message; indicate an action for a voicemail server on the network to process the spam report received from the client according to service provider policies; and indicate an action for a voicemail server on the network to make the appropriate changes in a message repository.

4. The method of claim 3 wherein the action is to delete or relocate the spam message, the method further comprising prompting the user to select deletion or relocation for the spam message.

5. The method of claim 4 further comprising transmitting another IMAP command to the voicemail server, said another IMAP command specifying deletion or relocation of the spam message.

6. The method of claim 5 further comprising sending a communication to the voicemail server, the communication establishing a user preference or default action for managing additional spam messages.

7. The method of claim 1 wherein the response indicates that the voicemail server performed the action on the spam message.

8. The method of claim 7 wherein the action performed on the spam message is deletion or relocation.

9. A computer-readable medium having computer-readable code executable by a processor of the portable electronic device to perform the method of claim 1.

10. A method performed by a network device executing a voicemail server, comprising:
receiving an IMAP command from a voicemail client on a mobile communication device, the IMAP command identifying a voicemail associated with the mobile communication device as being a spam message; and
sending, relative to the IMAP command, a response regarding the spam message to the voicemail client.

11. The method of claim 10 wherein the response suggests an action for the voicemail client to manage the spam message.

12. The method of claim 11 wherein the action is to delete or relocate the spam message.

13. The method of claim 12 further comprising receiving another IMAP command from the voicemail client specifying deletion or relocation of the spam message.

14. The method of claim 10 further comprising processing the spam message based on the action, wherein the response indicates that the voicemail server performed an action on the spam message.

15. The method of claim 14 wherein the action performed on the spam message is deletion or relocation.

16. The method of claim 10 further comprising receiving a communication from the voicemail client, the communication establishing a user preference or default action for managing additional spam messages.

17. A computer-readable medium having computer-readable code executable by a processor of a network device to perform the method of claim 10.

18. A mobile station including hardware and a computer readable medium storing instructions that, when executed, cause the mobile station to at least:
transmit an IMAP command to a voicemail server, the IMAP command identifying a voicemail associated with the mobile communication device as being a spam message; and
receive, relative to the IMAP command, a response regarding the spam message from the voicemail server.

19. The mobile station of claim 18, wherein the instructions are further configured to cause the mobile station to:
receive a user input indicating that the voicemail is spam; and
generate the IMAP command relative to the user input.

20. The mobile station of claim 18 wherein the response suggests an action for a voicemail client on the mobile communication device to manage the spam message.

21. The mobile station of claim 20 wherein the action is to delete or relocate the spam message, the instructions being further configured to prompt the user to select deletion or relocation for the spam message.

22. The mobile station of claim 21 wherein the instructions are further configured to cause the mobile station to transmit another IMAP command to the voicemail server, said another IMAP command specifying deletion or relocation of the spam message.

23. The mobile station of claim 22 wherein the instructions are further configured to cause the mobile station to send a communication to the voicemail server, the communication establishing a user preference or default action for managing additional spam messages.

24. The mobile station of claim 18 wherein the response indicates that the voicemail server performed the action on the spam message.

25. The mobile station of claim 24 wherein the action performed on the spam message is deletion or relocation.
